(19) United States
(12) Patent Application Publication
(10) Pub. No.: US 2005/0193618 A1
(43) Pub. Date: Sep. 8, 2005

(54) Fishing line guide ring of fishing rod

(76) Inventor: Moon-jae Yu, Seoul (KR)

Correspondence Address: Mark G. Lappin;McDermott Will & Emery LLP, 28 State Street, Boston, MA, 02109, US

(21) Appl. No.: 11/050,514

(22) Filed: Feb. 3, 2005

(30) Foreign Application Priority Data
Mar. 8, 2004 (KR) 2004-6198

(51) Int. Cl. A01K 87/04

(52) U.S. Cl. 43/24

(57) ABSTRACT

This invention proposes a fishing line guide ring including unevenness continuously formed in the inner circumference of the fishing line guide ring so as to reduce an area where a fishing line contacts the inner circumference of the fishing line guide ring when the fishing line meets with resistance generated at various angles by fish biting the fishing line, so that deformation of the fishing line due to frictional heat of the fishing line is minimized, the surface area of the fishing line guide ring is maximized to easily emit heat generated by the fishing line guide ring and the fishing line. The fishing line guide includes embossed surfaces or recesses and protrusions continuously formed in the respective inner circumferences of the fishing line guide rings to reduce the frictional area between the fishing line and the fishing line guide rings and to increase the surface area of the inner circumferences of the fishing line guide rings.

### BACKGROUND OF THE INVENTION

1. Field of the Invention

The present invention relates to a fishing line guide ring of a fishing rod, and more particularly, to a fishing line guide ring including unevenness continuously formed in the inner circumference of the fishing line guide ring so as to reduce the area where the fishing line contacts the inner circumference of the fishing line guide ring when the fishing line meets with resistance, so that deformation of the fishing line due to frictional heat between the fishing line and the fishing line guide ring is minimized, the surface area of the fishing line guide ring is maximized to easily radiate heat generated by contact between the fishing line guide ring and the fishing line.

2. Description of the Related Art

Generally, guides used in fishing rods are made of stainless steel and each includes a mainframe fixed to the fishing rod and a fishing line guide ring inserted into and fixed to the main frame.

As materials used in manufacturing fishing line guide rings, stainless steel, tungsten, or the like, subjected to the thermal treatment or hard plating, may be used. However, ceramic is used for the large majority of fishing line guide rings manufactured today.

The main frame fixes the fishing line guide ring, and the fishing line guide ring has a smooth surface such that the fishing line can slide on the surface of the fishing line guide ring smoothly.

As a tool to fix the fishing line guide ring to the fishing rod when manufacturing a fishing line guide, a stainless steel frame is mainly used.

As shown in FIGS. 1 and 2, a two-leg-four-part fishing line guide 1 includes a main frame 2 and a fishing line guide ring 3 fitted into the main frame 2.

The main frame 2 is formed with a circular, oval, or T-shaped through hole, and the fishing line guide ring 3 has the same shape as the through hole and is inserted into the through hole.

A support 6 is extended from the lower side of the main frame 2 and fixes the fishing line guide 1 to the fishing rod (not shown).

The support 6 is extended from the main frame 2 to form an obtuse angle between the support 6 and the main frame 2.

The fishing line 9 is inserted into the fishing line guide ring 3 and moves along a straight line due to a variable tensile force.

An auxiliary frame 22 is extended from the rear side of the main frame 2 and the auxiliary frame 22 and the main frame 2 are supported by each other.

In other words, the auxiliary frame 22 is extended from the upper end of the main frame 2.

The main frame 2 and the auxiliary frame 22 form an acute angle between the main frame 2 and the auxiliary frame 22, the support 6 is extended outwardly from the main frame 2 to form an obtuse angle between the main frame 2 and the support 6, and an auxiliary support 26 is extended from the auxiliary frame 22 to form an obtuse angle between the auxiliary frame 22 and the auxiliary support 26.

A plurality of fishing line guide rings 3 are provided to a plurality of fishing line guides 1 installed to the fishing rod (not shown) in the same straight line, and the respective inner circumferences of the fishing line guide rings 3 are connected by the fishing line 9.

In this state, the inner circumferences of the fishing line guide rings 3 have curved surfaces with a curvature predetermined so that the inner circumferences of the fishing line guide rings 3 contact the fishing line 9.

Since a force T1 that is applied when fish bite and draw the fishing line 9, and a repulsive force that is generated from the fishing rod and resists the force T1, are applied to the fishing line 9, the surface area of the fishing line 9 contacting the inner circumferences of the fishing line guide rings 3 become broader.

A structure is required that presses the fishing line guide ring to the frame when manufacturing the fishing line guide.

However, due to this structure, it is difficult to manufacture an accurate fishing line guide ring for reducing friction between the fishing line guide ring and the fishing line.

Hence, there have been several attempts to reduce frictional heat generated between the fishing line and the fishing line guide rings.

Moreover, in an attempt to reduce frictional heat, several materials have been used to manufacture the fishing line guide rings.

In other words, a Japan Patent No. 2000-191375 has proposed boron carbide as a material for the fishing line guide rings in order to enhance heat radiation of the fishing line guide ring, Japanese Patent No. 200-072543 has proposed the use of zircon as material for the fishing line guide ring in order to reduce the coefficient of friction of the fishing line, and Japanese Patent Laid-Open No. 11-069927 has proposed coating the inner circumferences of the fishing line guide rings with a film made of ceramic, metal, artificial leather, resin, or the like.

Moreover, Japanese Patent Laid-Open No. 10-262510 has proposed manufacturing the fishing line guide rings using SIC in order to reduce the coefficient of friction of the fishing line, Japanese Patent Laid-Open No. 09-208295 has used alumina ceramic in order to increase resistance against abrasion of the fishing line guide rings due to friction between the fishing line guide rings and the fishing line, and Japanese Patent Laid-Open No. 07-322796 has proposed coating the surfaces of the fishing line guide rings with a diamond coating film in order to reduce abrasion of the fishing line guide rings.

Japanese Patent Laid-Open No. 02-204362 has proposed manufacturing the fishing line guide rings using a predetermined amount of zirconia in order to prevent the fishing line from being broken and to increase resistance to breakage, and Japanese Patent Laid-Open No. 01-265841 has proposed coating the fishing line guide rings with metal and ceramic in order to reduce friction between the fishing line guide rings and the fishing line.

Meanwhile, U.S. Pat. No. 4,681,861 discloses a fishing line guide ring having excellent strength and rigidity by adding rare earth element T203 to SIC powder if necessary, and U.S. Pat. No. 6,141,899 discloses a fishing line guide ring having mean pores of approximate 10 μm formed on the surface of SIC in order to reduce friction.

Further, with respect to the structure of the fishing line guide ring, Japanese Patent Laid-Open Nos. 11-155429 and 09-163900 have proposed specific configurations of the fishing line guide rings.

Meanwhile, the applicant of this patent application has proposed a fishing line guide ring having at least one triangular cross-section.

However, although the conventional fishing line guide rings are manufactured using various materials in order to enhance abrasion resistance and provide high strength, high ductility, and heat release, performance of the conventional fishing line guide rings does not satisfy expectations, and since high priced material is used in order to obtain high performance of the fishing line guide rings, manufacturing costs are increased.

Moreover, although the conventional fishing line guide rings exhibits abrasion resistance, high strength, high ductility, and heat release, since the fishing line is drawn on the inner circumferences of the conventional fishing line guide rings by variable external force, frictional heat generated between the fishing line guide rings and the fishing line causes overheating of the inner circumferences of the fishing line guide rings, and the fishing line may be broken due to the broad area of friction between the fishing line and the fishing line guide rings.

### SUMMARY OF THE INVENTION

Therefore, the present invention has been made in view of the above and/or other problems, and it is an object of the present invention to provide a fishing line guide ring including various shaped unevenness continuously formed in the inner circumference and a side surface of the fishing line guide ring so as to reduce the area where a fishing line contacts the inner circumference of the fishing line guide ring, so that frictional heat generated between the fishing line and the fishing line guide ring is reduced, deformation or breakage of the fishing line due to excessive frictional heat is prevented, and the frictional heat generated by the fishing line guide ring and the fishing line is easily released.

In accordance with the present invention, the above and other aspects can be accomplished by the provision of a fishing line guide of a fishing rod in which a fishing line is continuously inserted into a plurality of aligned fishing line guide rings, the fishing line guide including embossed surfaces or recesses and protrusions continuously formed in the respective inner circumferences of the fishing line guide rings to reduce the frictional area between the fishing line and the fishing line guide rings and to increase the surface area of the inner circumferences of the fishing line guide rings.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is a perspective view illustrating a conventional fishing line guide of a fishing rod;

FIG. 2 is a sectional view of the conventional fishing line guide;

FIG. 3 is a perspective view illustrating a fishing line guide of a fishing rod according to the preferred embodiment of the present invention;

FIG. 4 is a sectional view of the fishing line guide ring in FIG. 3; and

FIGS. 5 and 6 are sectional views illustrating fishing line guide rings according to another embodiment of the present invention.

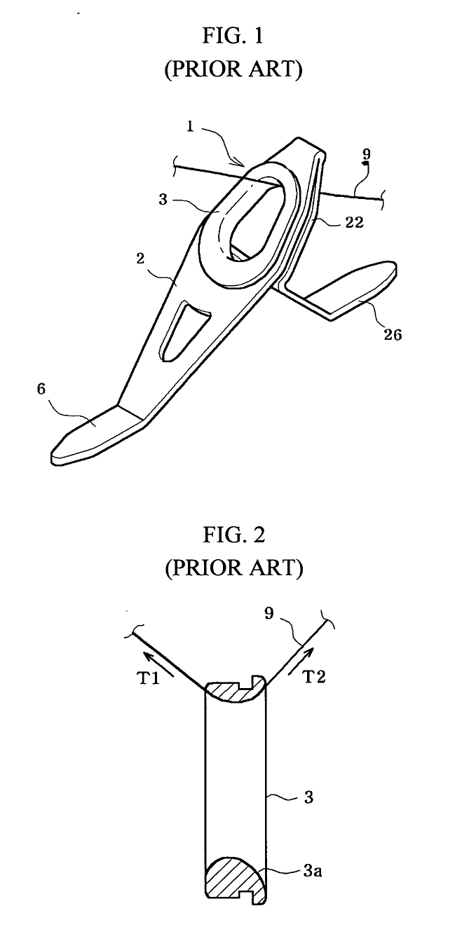

### DESCRIPTION OF THE PREFERRED EMBODIMENTS

Hereinafter, the preferred embodiment of the fishing line guide ring of a fishing rod according to the present invention will be described in detail with reference to the accompanying drawings.

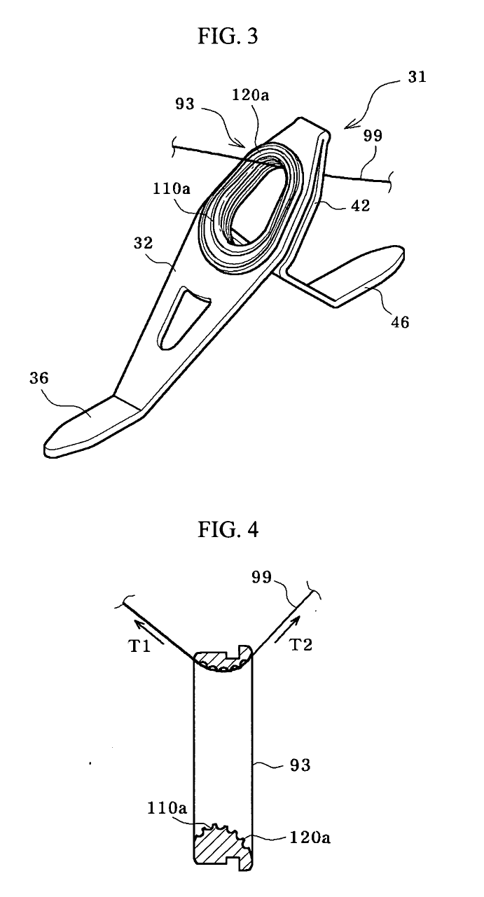

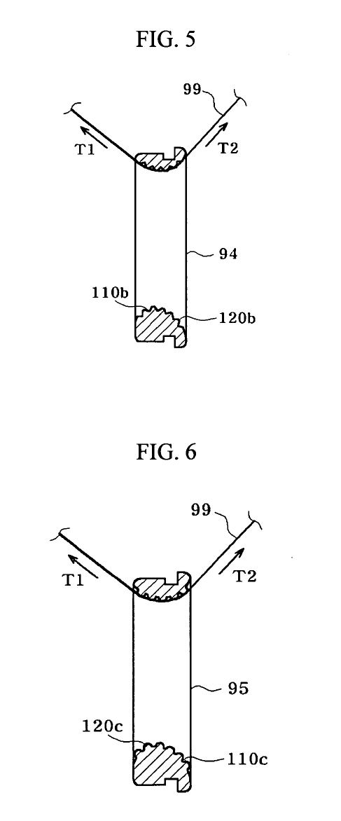

FIG. 3 is a perspective view illustrating the fishing line guide of a fishing rod according to the preferred embodiment of the present invention, FIG. 4 is a sectional view of the fishing line guide ring in FIG. 3, and FIGS. 5 and 6 are sectional views illustrating fishing line guide rings according to another embodiment of the present invention.

As shown in FIGS. 3 to 6, the fishing line guide ring of a fishing rod according to the preferred embodiment of the present invention, is a fishing line guide 31 of a fishing rod (not shown) in which a fishing line is continuously inserted into a plurality of aligned fishing line guide rings 93, 94, and 95, and includes embossed surface or recesses 110a, 110b, and 110c and protrusions 120a, 120b, and 120c continuously formed in the respective inner circumferences of the fishing line guide rings 93, 94, and 95 to reduce the frictional area between the fishing line 99 and the fishing line guide rings 93, 94, and 95 and to increase the surface area of the inner circumferences of the fishing line guide rings 93, 94, and 95.

As shown in FIG. 3, although the fishing line guide 31 may take various forms, a typical fishing line guide 31 is depicted in the drawings.

FIG. 3 depicts a two-leg-four-part fishing line guide 31.

The fishing line guide 31 includes a main frame 32 integrated with a support 36, and an auxiliary frame 42 integrated with an auxiliary support 46 which is integrally formed with the main frame 32.

A fishing line guide ring 93 is inserted into and connected to the main frame 32 and the auxiliary frame 42 of the fishing line guide 31.

As shown in FIGS. 3 and 4, the inner circumference and side surfaces of the fishing line guide ring 93 have recesses 110a and protrusions 120a that are continuously formed. The recesses 110a and the protrusions 120a reduce the contact area between the fishing line 99 and the fishing line guide ring 93 as much as possible.

The recesses 110a and the protrusions 120a generate frictional heat when the fishing line 99 contacts and slides on the fishing line guide ring 93, and reduces the contact area of the fishing line 99 in order to prevent the fishing line from being broken and deformed and to increase the surface area for releasing heat.

Meanwhile, the recesses 110a are depressed, and thus, naturally, the protrusions 120a are formed between the recesses 110a continuously formed in the inner circumference of the fishing line guide ring 93.

As shown in FIGS. 5 and 6, the fishing line guide rings 94 and 95 may selectively include the recesses 110b and 110c and the protrusions 120b and 120c in the form of various configurations.

The fishing line guide rings 94 and 95 may be made of various materials, but are preferably made of ceramic.

In other words, as shown in FIG. 5, the recesses 110b are formed in the inner circumference of the fishing line guide ring 94 at regular intervals in the form of triangular shapes.

Thus, the protrusions 120b are naturally protruded due to the recesses 110b.

The contact area between the fishing line 99 and the fishing line guide ring 94 is reduced by the recesses 110b and the protrusions 120b.

Moreover, as shown in FIG. 6, the recesses 110c are formed between the protrusions 120c continuously protruded from the inner circumference of the fishing line guide ring 95.

It is reasonable that the fishing line guide rings 93, 94, and 95 may selectively include the recesses 110a, 110b, and 110c and the protrusions 120a, 120b, and 120c that are continuously formed in various shapes.

If the contacting area between the fishing line guide rings 93, 94, and 95 and the fishing line 99 is reduced, the fishing line 99 moves in the fishing line guide rings 93, 94, and 95 due to the variable external tensile force and contacts the fishing line guide rings 93, 94, and 95 to reduce the frictional heat. As a result, the thermal deformation of the fishing line guide rings 93, 94, and 95 is decreased and it is possible to prevent the fishing line 99 from being broken.

Further, since the surface areas of the fishing line guide rings 93, 94, and 95 are increased by the recesses 110a, 110b, and 110c and the protrusions 120a, 120b, and 120c, the frictional heat generated by friction between the fishing line 99 and the fishing line guide rings 93, 94, and 95 is rapidly released by which areas that the fishing line guide rings 93, 94, and 95 are exposed to ambient air are increased.

In other words, as shown in FIGS. 4 to 6, external tensile force T1 and stress T2, resisting the external force T1, are applied to the fishing line 99 such that the contacting areas between the inner circumferences of the fishing line guide rings 93, 94, and 95 and the fishing line 99 are reduced by the recesses 110a, 110b, and 110c and the protrusions 120a, 120b, and 120c.

As described above, according to the fishing line guide ring in accordance with the present invention, the recesses and the protrusions are continuously formed in the fishing line guide ring that contacts the fishing line such that frictional heat due to the slide-contact of the fishing line guide ring with the fishing line is reduced so as to reduce thermal deformation of the fishing line guide ring, to prevent the fishing line from being broken by the tensile force because the fishing line becomes weak due to frictional heat, and to increase heat release due to the increased surface area.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fishing line guide of a fishing rod in which a fishing line is continuously inserted into a plurality of aligned fishing line guide rings, the fishing line guide comprising:
embossed surfaces or recesses and protrusions continuously formed in the respective inner circumferences of fishing line guide rings to reduce frictional area between the fishing line and the fishing line guide rings and to increase surface area of the inner circumferences of the fishing line guide rings.

2. The fishing line guide ring of a fishing rod as set forth in claim 1, wherein the inner circumference of the fishing line guide ring includes a continuously embossed configuration.
